(19) United States
(12) Patent Application Publication
(10) Pub. No.: US 2007/0082656 A1
(43) Pub. Date: Apr. 12, 2007

(54) Method and system for filtered pre-authentication and roaming

(75) Inventors: Jeremy Stieglitz, Menlo Park, CA (US); Timothy Olson, San Jose, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignee: Cisco Technology, Inc.

(21) Appl. No.: 11/247,674

(22) Filed: Oct. 11, 2005

(51) Int. Cl. H04M 1/66

(52) U.S. Cl. 455/411; 713/168; 370/328

(57) ABSTRACT

A system and method to manage the pre-authentication service by providing a network-centric, managed list of neighboring/logical access points from which a wireless station should pre-authenticate. An access point is provided with a pre-authentication table. When a wireless station associates with the access point, the access point transmits the pre-authentication table to the client. The client responsive to receiving the table only pre-authenticates with neighboring access points on the table.

### CROSS-REFERENCE TO RELATED APPLICATIONS

This application is related to U.S. application Ser. No. 11/051,394 filed Feb. 4, 2005 assigned to Cisco Technology, Inc., the assignee of the present invention.

### BACKGROUND OF THE INVENTION

The present invention relates generally to wireless local area networks (WLANs) and specifically to a method and system for directing and controlling wireless client pre-authentication and roaming.

The IEEE (Institute of Electrical and Electronic Engineers) 802.11i standard for Medium Access Control (MAC) Security Enhancements includes an optional phase for wireless station pre-authentication. Pre-authentication is designed to allow a supplicant to establish security associations with multiple access points (APs), in advance of direct association to one or more of those APs to improve performance in a mobile environment. Pre-authentication can be a useful performance enhancement, as new roaming associations will not include the full protocol overhead of a full re-authentication of the supplicant.

Per the 802.11 standard, pre-authentication uses the IEEE 802.1X protocol and state machines with EtherType 88-C7. To effect pre-authentication, the wireless station's (STA's) Supplicant sends an IEEE 802.1X EAPOL (Extensive Authentication Protocol over Local Area Network ) Start message with the destination address being the Basic Service Set Identifier (BSSID) of a targeted AP (access point), the receiver address (RA) being the BSSID of the AP with which the STA is associated. The target AP shall use a BSSID equal to the radio MAC address of its Authenticator.

In general, there is no particular rule set or algorithm to determine which APs a station should pre-authenticate to. Without such an algorithm, a client will attempt to pre-authenticate to as many APs as it can detect. As 802.11 networks increase capacity and become more and more dense, the number of possible pre-authentication targets can be very large.

As such, a client will generate very many “speculative” authentications, most of which will never be used. Furthermore, one of the problems with this approach is that a client may pre-authenticate needlessly to APs it could never associate to (such as APs on other floors, or in areas inaccessible to the user.)

### BRIEF SUMMARY OF THE INVENTION

In accordance with an aspect of the present invention, the present invention provides a system and method to better manage pre-authentication service by providing a network-centric managed list of neighboring/logical APs

By providing a managed neighbor list, clients can be better controlled as to how, when, whether, and/or where they pre-authenticate. In particular, clients can be instructed by the network system as to which APs are the next logical APs in any direction (as opposed to all APs a client may see). Such a directed list can take into account the actual physical relationship between APs, as opposed to only the over-the-air radio information a client can detect. In addition, the WLAN infrastructure system may have additional network-specific QOS, load balancing, radio density and radio coverage/interference knowledge, or security requirements that dictate the preferred approximate roaming APs for pre-association.

In accordance with an aspect of the present invention, there is disclosed herein a method and system for an access point to control pre-authentication. The method comprises maintaining a list of neighboring access points for pre-authenticating. The access point responsive to receiving an association request from a wireless station transmits the list of neighboring access points to the wireless station.

In accordance with an aspect of the present invention, there is disclosed herein a method and system for a wireless station to perform pre-authentication. The wireless station responsive to receiving a pre-authentication list from an access point pre-authenticates with neighboring access points on the pre-authentication list. The wireless station limits pre-authentication to only neighboring access points on the pre-authentication list.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification illustrates several aspects of the present invention, and together with the description serve to explain the principles of the invention.

FIG. 1 is a block diagram of a wireless local area network suitably adaptable to an aspect of the present invention.

FIG. 2 is a block diagram of an access point and a wireless station and the major components therein.

FIG. 3 is a block diagram of a computer system on which an embodiment of the present invention may be implemented.

FIG. 4 is a methodology for filtered pre-authentication and roaming implemented by an access point.

FIG. 5 is a methodology for filtered pre-authentication and roaming implemented by a wireless station.

### DETAILED DESCRIPTION OF INVENTION

Throughout this description, the preferred embodiment and examples shown should be considered as exemplars, rather than limitations, of the present invention. An aspect of the present invention is to better manage the pre-authentication service by providing a network centric, manage list of neighboring/logical APs from which an associated wireless station should pre-authenticate. Each AP in a network is pre-provisioned with pre-authentication tables (a list of neighboring access points). Each table defines the nearby logical APs that a client would need to roam. The tables can be configured to account for load-balancing, access policies, radio spectrum, coverage, capacity, and interference, and other location and/or logical information, such as whether to allow pre-authentication to APs on other floors near elevators, etc. Upon successful association to an AP, a client receives a pre-authentication table. The client only pre-authenticates to APs listed in the pre-authentication table. Optionally, the pre-authentication table can be optimized to manager other properties, such as when or whether to pre-authenticate to additional APs, or specify predetermined criterion for pre-authentication such as a minimal RSSI (Received Signal Strength Indication), QOS and call admission control parameters, location specific context for pre-authentication, and/or multicast group membership, etc. An aspect of the present invention is that it can improve security, performance, load balancing, AP utilization rates and battery consumption of wireless clients by directing and controlling client pre-authentication.

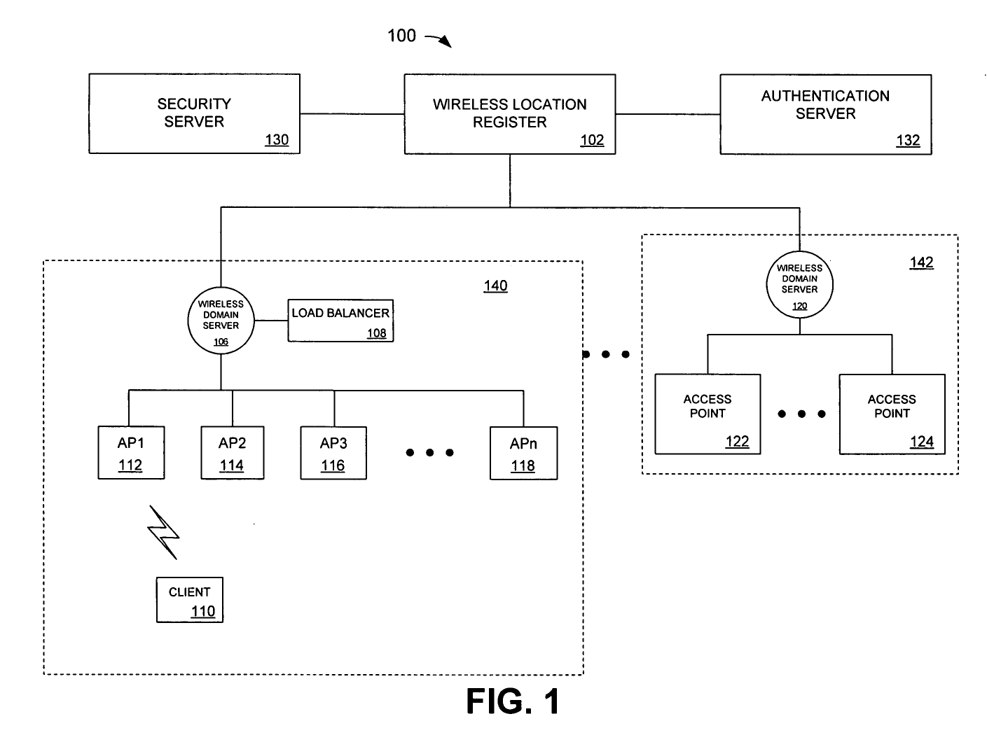

FIG. 1 is a block diagram of a wireless local area network (WLAN) 100 suitably adaptable to an aspect of the present invention. WLAN 100 is an exemplary hierarchical network having a plurality of subnets 140, 142 managed by wireless domain servers 106,120 respectively. Wireless location register (WLR) 102 is the root infrastructure node of WLAN 100. Coupled to WLR 102 are a Security Server 130 and Authentication Server (AS) 132. Security server 130 can be employed for key management. For example, as client (a wireless station or ‘STA’) 110 associates with AP1 112, Security Server 130 can distribute the session keys to be used for communication between AP1 112 and client 110. AS 132 provides authentication services for clients attempting to access WLAN 100, and can optionally be used for authenticating the infrastructure nodes, e.g., WDSs 106, 108 and/or APs 112,114, 116,118,122,124.

In operation, AP1 112 maintains a list (or table) of neighboring access points for pre-authentication. As client 110 associates with AP1 112, AP1 112 transmits the list of neighboring access points to client 112.

The list of neighboring access can be configured any number of ways. For example, the list can be configured with only APs within subnet 140, such as AP2 114, AP3,116 . . . APn 118. As another example, the list can be configured with the nearest physically located APs which can include APs belonging to other subnets, for example AP 122 . . . AP 124 belonging to subnet 142. For pre-authenticating a client with APs on a different subnet, the APs on the other subnet may have to contact their WDS (for example WDS 120 for AP 122, AP1 24), which may in turn have to contact WLR (e.g., WLR 102) and/or the WDS of the currently associated AP for the client (e.g., WDS 106 the WDS for AP 112, the current parent AP for client 110) in order to pre-authenticate the client.

As another alternative, the list of neighboring access points can account for load balancing. For example, a load balancer 108 can be co-located (or coupled to) WDS 106. Load balancer 108 functions to determine the current load on each AP, AP1 112, AP2 114, AP3 116 . . . APn 118 in subnet 140. The list of neighboring access points can be modified based on the current loads on the access points (e.g., AP1 112, AP2 114, AP3 116 . . . APn 118) in subnet 140. For example, if AP3 116 has a very demanding load and is near (or exceeded) its admission capacity, load balancer 108 can have WDS 106 remove AP3 116 from the neighboring access point list. As the load on AP3 116 decreases and AP3 116 achieves sufficient admission capacity to allow the association of new clients, load balancer 108 has WDS 106 restore AP3 116 to the neighboring access point list. Those skilled in the art can readily appreciate that although load balancer 108 is illustrated as coupled to WDS 106, additional load balancers can be employed or load balancer 108 can be co-located with WLR 102.

In addition to the aforementioned options for the list of neighboring access points, the list neighboring access points can be further optimized to manager other properties of pre-authentication such as by specifying a predetermined criterion (e.g., when, how) or network policies. For example, the list of neighboring access points can specify that pre-authentication should not occur unless the client observes a specified (e.g., minimum) RSSI. As another example, the list can be based on the time of day. For example a large facility may shut down access points at night or after hours; therefore the list would specify which access points to pre-authenticate with during the day and which ones at night or after hours. It is further contemplated that the access point (e.g., AP 112) would have multiple lists. For example, the AP can maintain a separate list of neighboring access points for each multicast group. As another example, the AP can maintain separate lists that depend on which protocol the client (e.g., client 110) supports. For example, if client 110 does not support the 802.11n protocol, then AP 112 sends client 112 a list of neighboring access points of non 802.11n complaint access points. Alternatively, if client 110 is an 802.11n compliant client, then AP 112 sends a list of neighboring access points including 802.11n compliant access points.

After client 110 receives the list of neighboring access points (pre-authentication list) from AP1 112, client 112 initiates pre-authentication with the neighboring access points on the pre-authentication list. Client 112 limits pre-authentication to only neighboring access points on the pre-authentication list. In a preferred embodiment, the list is received after associating with AP1 112. If the pre-authentication list comprises a predetermined criterion for pre-authentication (e.g., the client is complaint with a specified protocol or a physical property such as the client receives an RSSI at or above a predetermined level), the client only associates with APs meeting the predetermined criterion. For example, if client 110 belongs to a multicast group for receiving a multicast stream and only AP3 116 supports the multicast stream, the client 110 only pre-authenticates with AP3 116. Client 110 can be configured to roam only to an AP that has already been pre-authenticated.

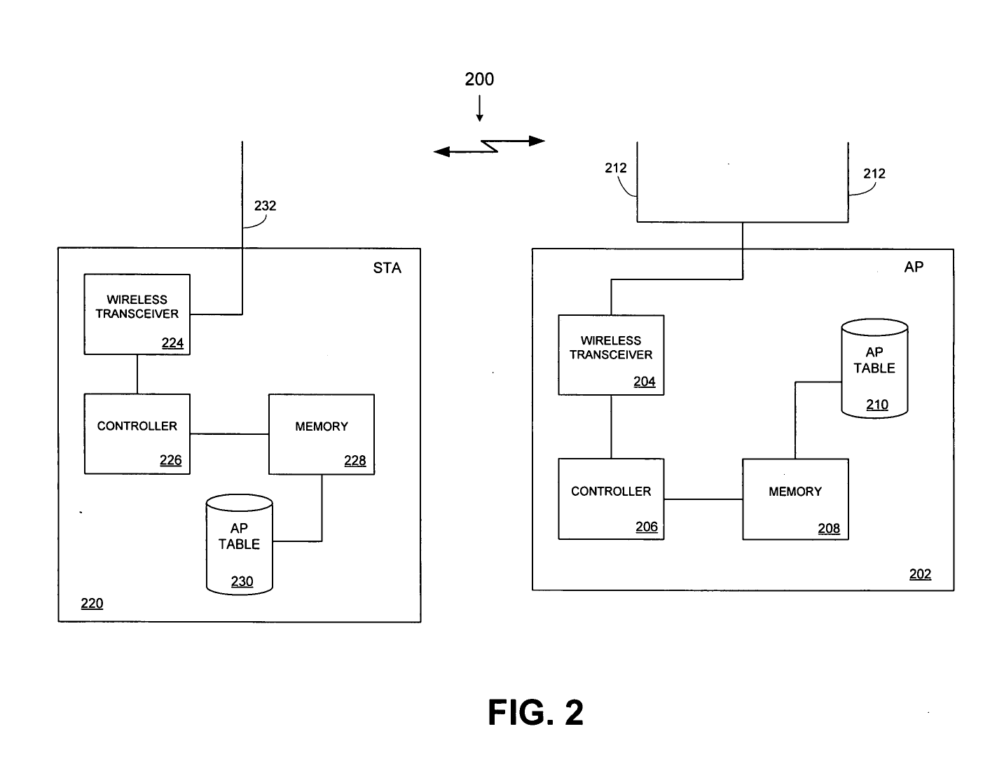

FIG. 2 is a block diagram 200 illustrating an access point (AP) 202 and a wireless station (STA) 220 and the major components therein. As will be described herein below AP 202 is configured to maintain a list of neighboring access points (AP Table) 210 that is wirelessly transmitted to STA 220. STA 220 stores the list, AP Table 230, and is responsive to receiving the list to only pre-authenticate with APs in AP Table 230.

AP 202 comprises wireless transceiver 204. Wireless transceiver 204 is operable to send and receive wireless signals from antennas 212. For received signals, wireless transceiver comprises circuitry for demodulating and frequency converting the received signals, and if desired any A/D circuitry for performing analog to digital signal conversion. For transmitting signals, wireless transceiver 204 comprises circuitry for D/A conversion, frequency conversion and modulation. If desired, wireless transceiver 204 also comprises encoding/decoding circuitry.

Controller 206 is coupled to wireless transceiver 204. Controller 206 is operable for controlling the operation of wireless transceiver 204. Controller 206 suitably comprises logic for performing the control operations and functionality described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software.

Controller 206 suitably comprises memory 208. Memory 208 can be internal is or external to controller 206. Within memory 208 is stored a list of neighboring access points for pre-authentication, or pre-authentication list (AP Table) 210. Logic in controller 206 is configured to maintain the list of neighboring access points 210 for pre-authenticating. Controller 206 is responsive to receiving an association request from wireless station 220 via wireless transceiver 204 to transmitting the list of neighboring access points 210 via wireless transceiver 204 to the wireless station 220.

Controller 206 can be configured to be responsive to modify the list of neighboring access points 210 based on the load of the neighboring access points. For example, a load balancer (not shown) can be communicatively coupled to controller 206. The list of neighboring access points can be modified based on the current loads on the access points. For example, if an AP on the list of neighboring access points 210 has a very demanding load and is near (or exceeded) its admission capacity, the load balancer can communicate this data to controller 206 which is responsive to remove that AP from the neighboring access point list. As the load on the de-listed AP decreases and the de-listed AP achieves sufficient admission capacity to allow the association of new clients, load balancer communicates this data to controller 206 which is responsive to restore the de-listed AP to the list of neighboring access points 210.

Controller 206 can be configured to maintaining one or more lists of neighboring access points based on access policies. For example, controller 206 can be configured to send a list 210 that has only APs logically coupled to AP 202, such as APs belonging to the same subnet. As another example, the list 210 can be configured with the nearest physically located APs which can include APs belonging to other subnets.

In addition to the aforementioned options for the neighboring access point list, controller 206 can be configured to further optimized the list of neighboring access points 210 to manager other properties of pre-authentication such as by specifying a predetermined criterion (e.g., when, how) or network policies. For example, the list of neighboring access points 210 can specify that pre-authentication should not occur unless the client observes a specified (e.g., minimum) RSSI. As another example, the list 210 can be based on the time of day. For example a large facility may shut down access points at night or after hours; therefore the list could specify which access points to pre-authenticate with during the day and which ones at night or after hours. Yet another option, controller 206 can maintain a separate list of neighboring access points 210 for each multicast group. Still another option, controller 206 can maintain separate lists 210 that depend on which protocol the client (e.g., client 220) supports. For example, if client 220 does not support the 802.11n protocol, then controller sends client 220 a list of neighboring access points 210 of non 802.11n complaint access points. Alternatively, if client 220 is an 802.11n compliant client, then controller 206 sends a list of neighboring access points 210 including 802.11n compliant access points.

Wireless station (STA) 220 comprises wireless transceiver 224. Wireless transceiver 224 is operable to send and receive wireless signals from antennas 232. For received signals, wireless transceiver comprises circuitry for demodulating and frequency converting the received signals, and if desired any A/D circuitry for performing analog to digital signal conversion. For transmitting signals, wireless transceiver 224 comprises circuitry for D/A conversion, frequency conversion and modulation. If desired, wireless transceiver 224 also comprises encoding/decoding circuitry.

Controller 226 is coupled to wireless transceiver 224. Controller 226 is operable for controlling the operation of wireless transceiver 224. Controller 226 suitably comprises logic for performing the control operations and functionality described herein.

Controller 226 is configured to initiate an association with access point 202. Controller 226 triggers a signal from wireless transceiver 224 that is sent to AP 202. Wireless transceiver 224 receives a pre-authentication list from access point 202 that is forwarded to controller 226. Controller 226 stores the list in AP Table 230 which is coupled to memory 228. Controller 226 is responsive to receiving the pre-authentication list to initiate pre-authentication only with neighboring access points on the pre-authentication list. Furthermore, controller 226 can be configured to only roam to access points that it has already pre-authenticated.

Optionally, the pre-authentication list includes a predetermined criterion for pre-authenticating with an AP. For example, the list of neighboring access points can specify that pre-authentication should not occur unless the client observes a specified (e.g., minimum) RSSI. As another example, the list can be based on the time of day. For example a large facility may shut down access points at night or after hours; therefore the list would specify which access points to pre-authenticate with during the day and which ones at night or after hours. Controller 206 is responsive to the predetermined criterion to only pre-authenticate with APs meeting the predetermined criterion.

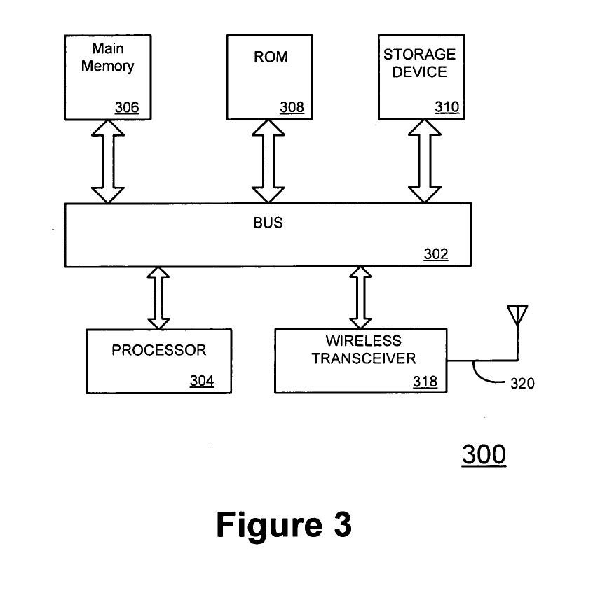

FIG. 3 is a block diagram of a computer system 300 on which an embodiment of the present invention may be implemented. Computer system 300 is suitably adaptable to perform the functionality of an access point (e.g., AP 20 2 in FIG. 2 and/or APs 112, 114, 116, 118, 122, 124 in FIG. 1), a wireless station (e.g., client 110 in FIG. 1 or STA 220 in FIG. 2), a wireless domain server (e.g., WDS 106, 108 in FIG. 1), WLR 102 (FIG. 1), Authentication Server 132 (FIG. 1) and/or Security Server 130 (FIG. 1).

Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

An aspect of the present invention is related to the use of computer system 300 for filtered pre-authentication and roaming. According to one embodiment of the invention, filtered pre-authentication and roaming is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to non-volatile media, volatile media, and transmission media. Non-volatile media include for example optical or magnetic disks, such as storage device 310. Volatile media include dynamic memory such as main memory 306.

Computer system 300 also includes a wireless transceiver 318 coupled to bus 302. Wireless transceiver 318 provides a two-way data communication with a wireless link via antenna 320. Computer system 300 can send messages and receive data, including program codes, through antenna 320, and wireless transceiver 318. For example, application programs may be received by antenna 320 and wireless transceiver 318 and downloaded into main memory 306 or storage device 310. In accordance with an aspect of the present invention, one such downloaded application provides for filtered pre-authentication and roaming as described herein.

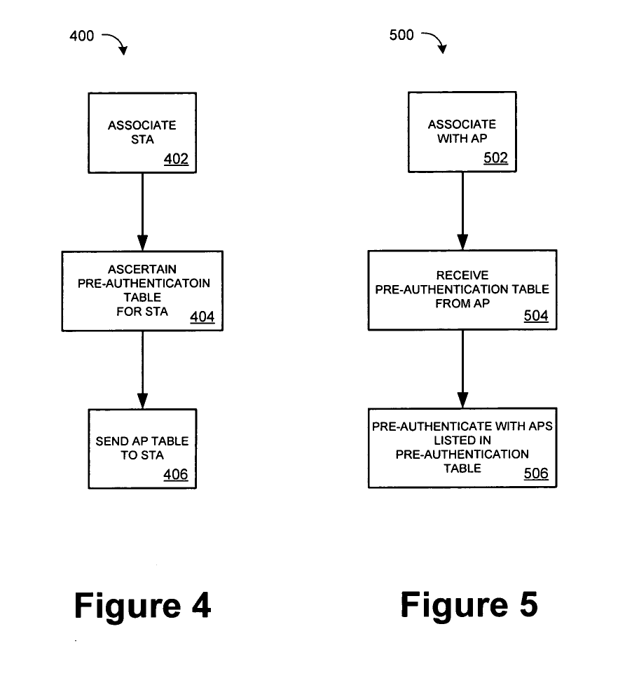

In view of the foregoing structural and functional features described above, methodologies in accordance with various aspects of the present invention will be better appreciated with reference to FIGS. 4-5. While, for purposes of simplicity of explanation, the methodologies of FIGS. 4-5 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention. Embodiments of the present invention are suitably adapted to implement the methodology in hardware, software, or a combination thereof.

FIG. 4 is a block diagram of a method of operation 400 for implementing filtered pre-authentication and roaming by an access point, or other infrastructure node. The AP maintains a list (or plurality of list) of neighboring access points for pre-authentication. At 402, a wireless client (STA) associates with the AP. This step would also include any authentication and key exchanges.

At 404, the AP ascertains the appropriate pre-authentication list (table) for the client. The list of neighboring access points can be configured any number of ways. For example, the list can be configured with only APs belonging to the same subnet. As another example, the list can be configured with the nearest physically located APs which can include APs belonging to other subnets.

As another alternative, the list of neighboring access points can account for load balancing. The list of neighboring access points can be modified based on the current loads on the neighboring access points. For example, if an AP has a very demanding load and is near (or exceeded) its admission capacity, the AP can be removed (de-listed) from the neighboring access point list. As the load on the de-listed AP decreases and the AP achieves sufficient admission capacity to allow the association of new clients, the de-listed AP can be restored to the neighboring access point list.

In addition to the aforementioned options for the list of neighboring access points, the list neighboring access points can be further optimized to manager other properties of pre-authentication such as by specifying a predetermined criterion (e.g., when, how) or network policies. For example, the list of neighboring access points can specify that pre-authentication should not occur unless the client observes a specified (e.g., minimum) RSSI. As another example, the list can be based on the time of day. For example a large facility may shut down access points at night or after hours; therefore the list would specify which access points to pre-authenticate with during the day and which ones at night or after hours.

It is further contemplated that the access point would have multiple lists. For example, the AP can maintain a separate list of neighboring access points for each multicast group. As another example, the AP can maintain separate lists that depend on which protocol the client supports. For example, if the client does not support the 802.11n protocol, then the AP selects a list of neighboring access points with non 802.11n complaint access points. Alternatively, if the client is an 802.11n compliant client, then the AP selects a list of neighboring access points including 802.11n compliant access points.

At 406, the list of neighboring access points for pre-authentication (AP table) is sent to the wireless client. The list can be sent by whatever communication means has been established between the access point and the client.

FIG. 5 is a block diagram of a method of operation 500 for a wireless station configured in accordance with an aspect of the present invention. The wireless station may have been already pre-authenticated with the AP or may be an AP wherein no pre-authentication was initiated.

At 502, the wireless station associated with the AP. This step would include any authentication and key exchanges transactions required for the association as well as establishing communication between the station and the AP. At 504, the station receives a pre-authentication table (or pre-authentication list or list of neighboring access points for pre-authentication). The table may be received as part of the association process, sent automatically subsequent to the association process, or the station may request the list.

At 506, the station pre-authenticates with access points listed in the pre-authentication table. In a preferred embodiment, the station limits pre-authentication to only those APs listed in the pre-authentication table.

Optionally, the pre-authentication table can include a predetermined criterion for pre-authenticating with an AP. For example, the pre-authentication can specify that pre-authentication should not occur unless the client observes a specified (e.g., minimum) RSSI. As another example, the table can be based on the time of day. For example a large facility may shut down access points at night or after hours; therefore the list would specify which access points to pre-authenticate with during the day and which ones at night or after hours. The wireless station is responsive to the predetermined criterion to only pre-authenticate with APs meeting the predetermined criterion.

An aspect of the present invention is that it can reduce the number of pre-authentication requests that are performed. For large scale systems, the present invention can reduce the overall workload on the RADIUS server system.

Yet another aspect of the present invention is that it can be used to help contain and/or prevent associations to protected APs. An aspect of the present invention may also help prevent/detect DOS (denial of service) attacks by isolating which clients should be pre-authenticating to which APs.

Still another aspect of the present invention is that it may provide some incremental benefits to managing and distributing the load of wireless users across multiple APs. Clients can be diverted from overloaded APs and directed to APs having sufficient admission capacity.

Still yet another aspect of the present invention is that the present invention can increase power savings and help prolong battery life. By only authenticating to the immediate neighbors of the associated AP instead of all detected APs the client may realize significant battery savings.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

1. A method for an access point to control pre-authentication, comprising:
maintaining a list of neighboring access points for pre-authenticating;
receiving an association request from a wireless station; and transmitting the list of neighboring access points to the wireless station.

2. A method according to claim 1, further comprising adding a new neighboring access point to the list of neighboring access points for load balancing.

3. A method according to claim 1, further comprising removing a neighboring access point from the list for load balancing.

4. A method according to claim 1, the maintaining a list of neighboring access points further comprising maintaining a plurality of lists of neighboring access points based on access policies.

5. A method for a wireless station to perform pre-authentication, comprising:
receiving a pre-authentication list from an access point; and
pre-authenticating with neighboring access points on the pre-authentication list;
wherein the wireless station limits pre-authentication to only neighboring access points on the pre-authentication list.

6. A method according to claim 5, further comprising associating with an access point.

7. A method according to claim 5, wherein the pre-authentication list comprises a predetermined criterion for pre-authenticating with neighboring access points on the list, the pre-authenticating further comprising pre-authenticating only with access points meeting the predetermined criterion.

8. A method according to claim 7, wherein the predetermined criterion is a minimum received signal strength indication.

9. An access point, comprising:
a wireless transceiver; and
a controller for controlling the operation of the wireless transceiver coupled to the wireless transceiver;
wherein the controller is configured to maintain a list of neighboring access points for pre-authenticating, the controller is responsive to receiving an association request from a wireless station via the wireless transceiver to transmitting the list of neighboring access points via the wireless transceiver to the wireless station.

10. An access point according to claim 9, further comprising the controller responsive to modify the list of neighboring access points based on the load of the neighboring access points.

11. An access point according to claim 9, further comprising the controller configured to maintaining a plurality of lists of neighboring access points based on access policies.

12. A wireless station, comprising:
a wireless transceiver; and
a controller for controlling the operation of the wireless transceiver coupled to the wireless transceiver;
wherein the controller is configured to initiate an association with an access point and is configured for receiving a pre-authentication list from the access point; and
wherein the controller is responsive to receiving the pre-authentication list to initiate pre-authentication only with neighboring access points on the pre-authentication list.

13. A wireless station according to claim 12, wherein the pre-authentication list comprises a predetermined criterion for pre-authenticating with neighboring access points on the list, the controller is configured to pre-authenticate only with access points meeting the predetermined criterion.

14. A computer program product having a computer readable medium having computer program logic recorded thereon for filtered pre-authentication and roaming comprising:
means for maintaining a list of neighboring access points for pre-authenticating;
means for receiving an association request from a wireless station; and
means for transmitting the list of neighboring access points to the wireless station.

15. A computer program product according to claim 14, further comprising means for modifying the list of neighboring access points based on the load of the neighboring access points.

16. A computer program product according to claim 14, the means for maintaining a list of neighboring access points further comprises means for maintaining a plurality of lists of neighboring access points based on access policies.

17. A computer program product having a computer readable medium having computer program logic recorded thereon for filtered pre-authentication and roaming comprising:
means for receiving a pre-authentication list from an access point; and
pre-authenticating with neighboring access points on the pre-authentication list;
wherein the wireless station limits pre-authentication to only neighboring access points on the pre-authentication list.

18. A computer program product according to claim 17, further comprising means for associating with the access point.

19. A computer program product according to claim 17, wherein the pre-authentication list comprises a predetermined criterion for pre-authenticating with neighboring access points on the list, the pre-authenticating further comprising pre-authenticating only with access points meeting the predetermined criterion.

20. A computer program product according to claim 19, wherein the predetermined criterion is a minimum received signal strength indication.
